(19) United States
(12) Patent Application Publication
(10) Pub. No.: US 2022/0315212 A1
(43) Pub. Date: Oct. 6, 2022

(54) DISTRIBUTED PROPULSION STRUCTURE

(71) Applicant: Bell Textron Inc., Fort Worth, TX (US)

(72) Inventors: Guillaume Noiseux Boucher, Mirabel (CA); Sebastien Duval, Terrebonne (CA); Guillaume Biron, Blainville (CA); Marc Ouellet, Sainte-Sophie (CA)

(73) Assignee: Bell Textron Inc., Fort Worth, TX (US)

(21) Appl. No.: 17/223,887

(22) Filed: Apr. 6, 2021

(51) Int. Cl. B64C 27/82

(52) U.S. Cl. CPC B64C 27/82; B64C 2027/8227; B64C 2027/8254; B64C 2027/8209

(57) ABSTRACT

A rotorcraft includes a substantially rigid structural body. The structural body has an internal cavity and an aperture extending entirely through the structural body. The rotorcraft further includes at least one of a tail boom and a fuselage. The rotorcraft further includes a propulsion device disposed at least partially within the internal cavity and at least partially within the aperture. The propulsion device is carried by the structural body so that forces are transferred from the propulsion device to at least one of the tail boom and the fuselage via the structural body.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Distributed propulsion systems typically comprise motors supported by motor mounts that are supported by an internal airframe. Such airframes typically comprise many subassemblies that add weight, complexity, and cost to the production of a rotorcraft. In rotorcraft with existing Electrically Distributed Anti-Torque (EDAT) system, the overall weight to be supported by a tail boom of the rotorcraft is significantly increased as the number of electrically powered fan motors is increase. Because the electrically powered fan motors themselves are heavy, current EDAT systems and current systems for connecting the EDAT systems to tail booms renders the overall performance of the rotorcraft inefficient insofar as the increased weight reduces a fuel efficiency and payload capacity of the rotorcraft.

### BRIEF DESCRIPTION OF THE DRAWINGS

FIG. 1 is an orthogonal side view of a rotorcraft comprising a Distributed Propulsion Support Structure (DPSS) according to this disclosure.

FIG. 2 is a partial orthogonal side view of the DPSS of FIG. 1.

FIG. 3 is a partial orthogonal cutaway view of the DPSS of FIG. 2.

FIG. 4 is a flow chart of a method of constructing the DPSS of FIG. 2.

FIG. 5 is an orthogonal end view of a multipart DPSS according to this disclosure.

FIG. 6 is an oblique view of a first portion of the multipart DPSS of FIG. 5.

FIG. 7 is an oblique view of a second portion of the multipart DPSS of FIG. 5.

FIG. 8 is an oblique exploded view of the multipart DPSS of FIG. 5.

FIG. 9 is a flow chart of a method of constructing the multipart DPSS of FIG. 5.

FIG. 10 is an orthogonal side view of an exogrid DPSS according to this disclosure.

FIG. 11 is an oblique view of the exogrid DPSS of FIG. 10.

FIG. 12 is a flow chart of a method of constructing the exogrid DPSS of FIG. 10.

### DETAILED DESCRIPTION

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

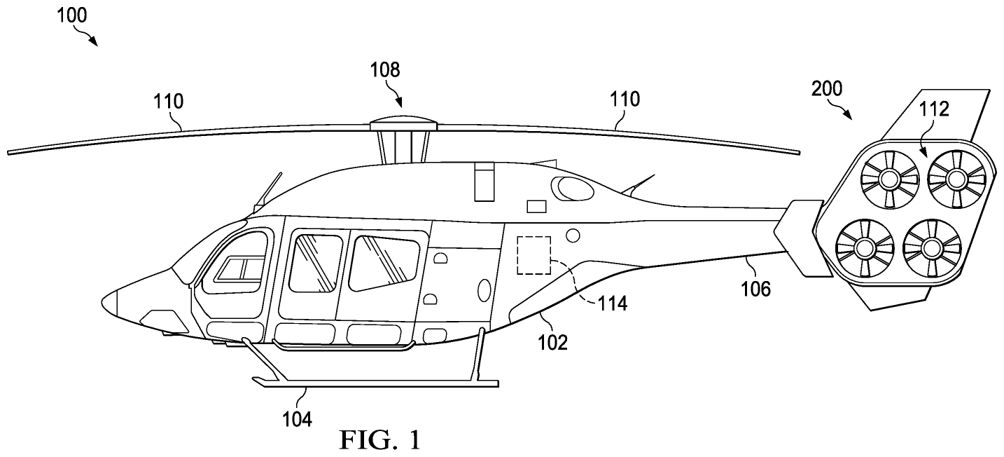

Referring now to FIG. 1, a rotorcraft 100 according to an embodiment of this disclosure is shown. Rotorcraft 100 comprises a fuselage 102, landing gear 104, tail boom 106, main rotor system 108, and main rotor blades 110. Rotorcraft 100 further comprises an Electrically Distributed Anti-Torque (EDAT) system 112 that is carried by the tail boom 106, and electrical power source 114 supplies power from rotorcraft 100 to EDAT 112. As will be explained in detail below, EDAT 112 is structurally supported by a Distributed Propulsion Support Structure (DPSS) 200.

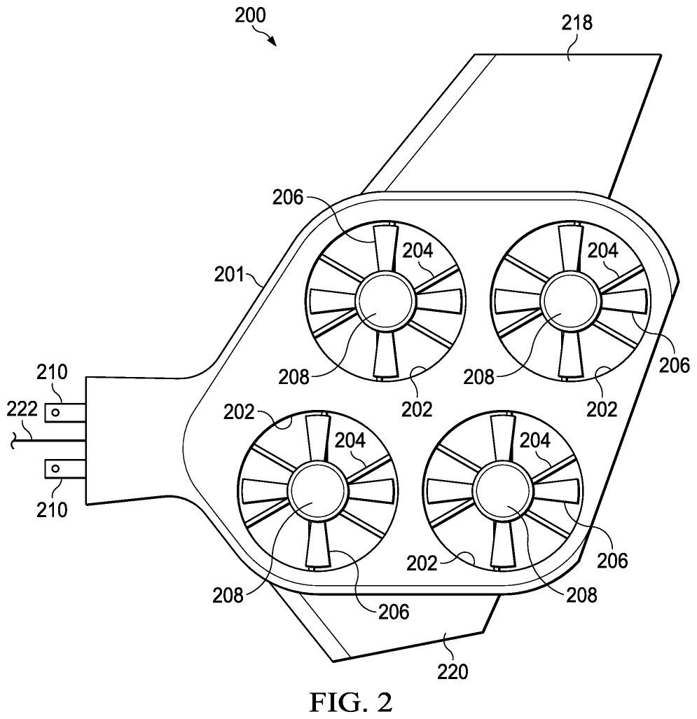

Still referring to FIG. 1 and additionally referring to FIG. 2, the EDAT 112 is carried by a DPSS 200 that comprises a structural body 201. In this embodiment, four fan apertures 202 extend fully laterally through structural body 201, although in other embodiments, a structural body can comprise two, three, or more than four fan apertures. In each fan aperture, a fan motor mount 204, a propulsion device such as a fan motor 208, and fan blade assembly 206 are disposed in fan aperture 202 so that during operation of the EDAT 112, air can be selectively passed through the fan apertures 202. In alternative embodiments, the propulsion device can comprise any other suitable propulsion device, such as, but not limited to, a hydraulically powered motor, a pneumatically powered motor, or any other thrust generating device. In this embodiment, each fan motor mount 204 is supported by structural body 201 so that forces generated by the EDAT are transferred from the fan motor mounts 204 to the structural body 201. In this embodiment, the structural body 201 is integrally formed as a unitary structure. Body 201 can be constructed of metal, metal alloys, carbon fiber, and/or any other suitable material or composite construction. Body 201 can be formed by machining and/or casting processes. In this embodiment, an upper vertical stabilizer 218 and a lower vertical stabilizer 220 are integrally formed with structural body 201 and improve the aerodynamic characteristics of the DPSS 200. A tail boom adapter 210 structurally couples DPSS 200 to tail boom 106 of rotorcraft 100, and an electrical power source 114, such as a battery or a generator, is connected to electrical wiring 222 to power fan motors 208.

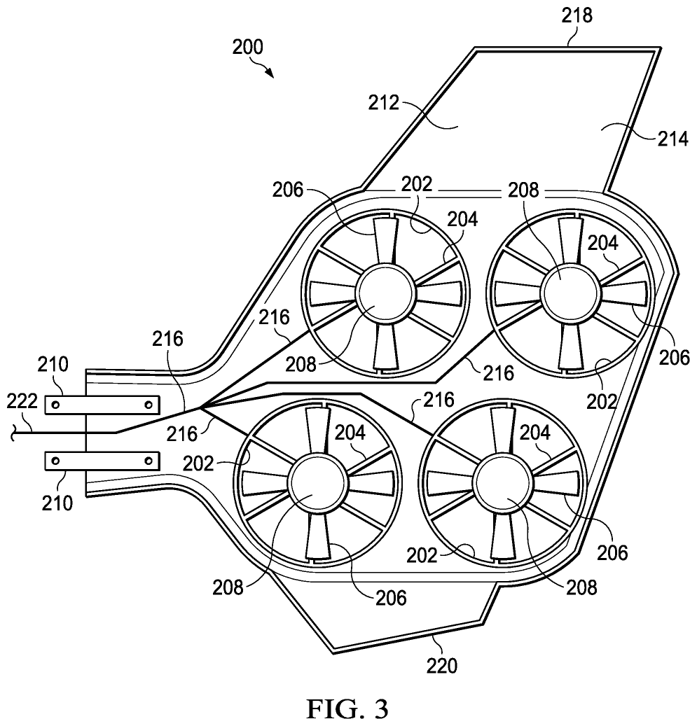

FIG. 3 is a cutaway view of the DPSS 200. In constructing DPSS 200, carbon fiber fabric can be laid over a mold or surface to create structural body 201 to form an internal cavity 212 within DPSS 200. In alternative embodiments, a structural body substantially similar to structural body 201 can be shaped using other suitable means of manufacturing, such as resin transfer or bladder molding. In this embodiment, internal cavity 212 is strategically at least partially filled with a core 214 which can serve as a stiffening agent, thereby improving a structural rigidity of DPSS 200. Core 214 can comprise a syntactic core, foam core, and/or honeycomb core structure. In some embodiments, metal stringers, carbon fiber stringers, and/or any other suitable stiffening agents can be disposed within internal cavity 212 to increase the area moment of inertia of DPSS 200. The core 214 can have preformed tubular cavities 216 for routing electrical wiring 222 to between electrical power source 114 and the fan motors 208 carried by DPSS 200. In alternative embodiments, fan motor mounts can be an incorporated into a structural body as an integral part of a structural body substantially similar to structural body 201.

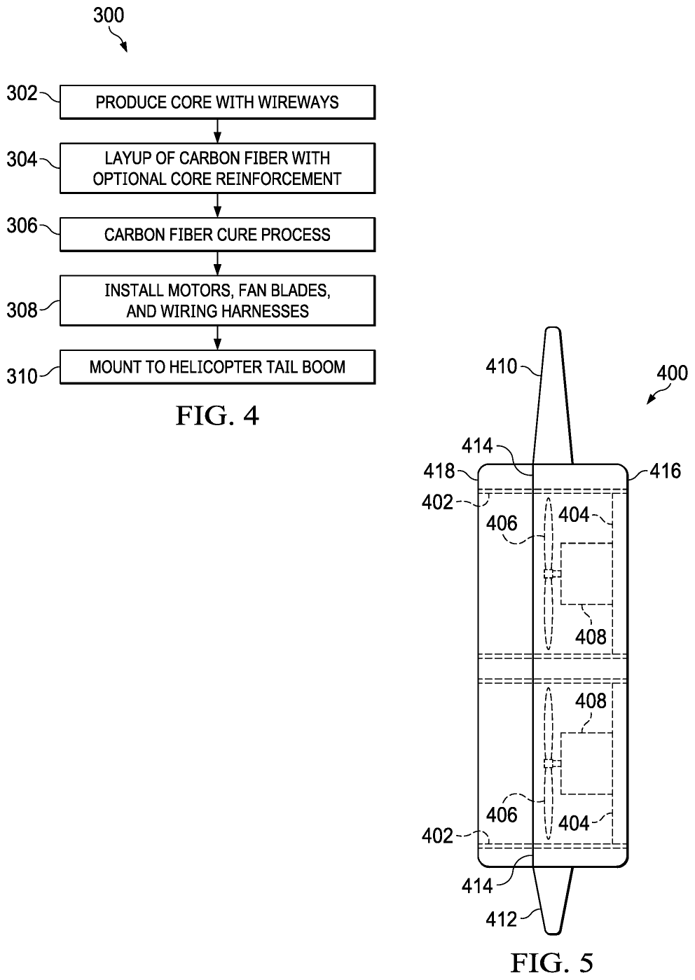

FIG. 4 is a flowchart of a method of producing a distributed propulsion support structure such as DPSS 200. At block 302, method 300 can begin by fabricating a core such as core 214. Method 300 can continue at block 304, by laying carbon fiber fabric in place and forming a structural body such as structural body 201. The carbon fiber fabric can be laid onto dedicated mold(s) by hand, by an Automated Fiber Placement (AFP) robot, by a co-cure process, use of a material with pre-impregnated resin (pre-preg), or any combination thereof. Method 300 can progress at block 306 by curing the structural body 201 in an oven or autoclave. Next at block 308, method 300 can progress by installing fan motor mounts such as fan motor mounts 204 to the structural body, installing fan motors to fan motor mounts, fan blades to fan motors, and electrically connecting electrical wiring 222 between the electrical power source and the fan motors. At block 310, method 300 can progress by structurally joining the DPSS 200 to the tail boom using a tail boom adapter such as tail boom adapter 210, thereby fully structurally supporting the EDAT by the tail boom via the structural body of the DPSS 200.

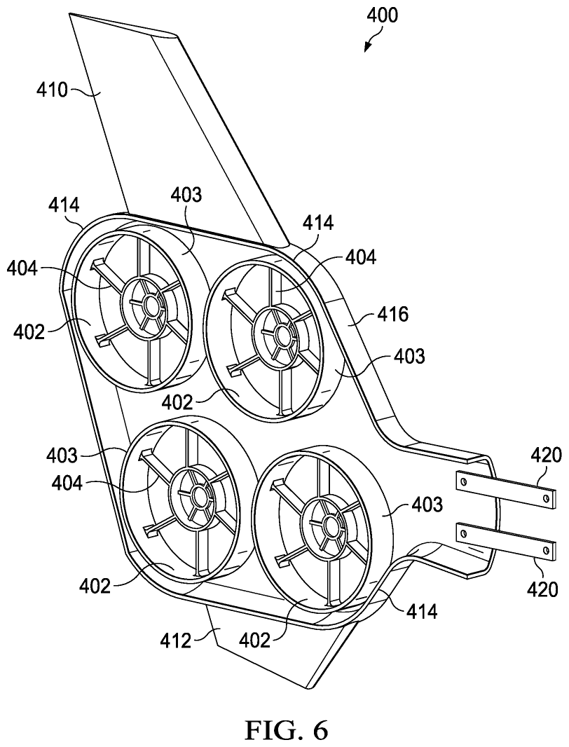

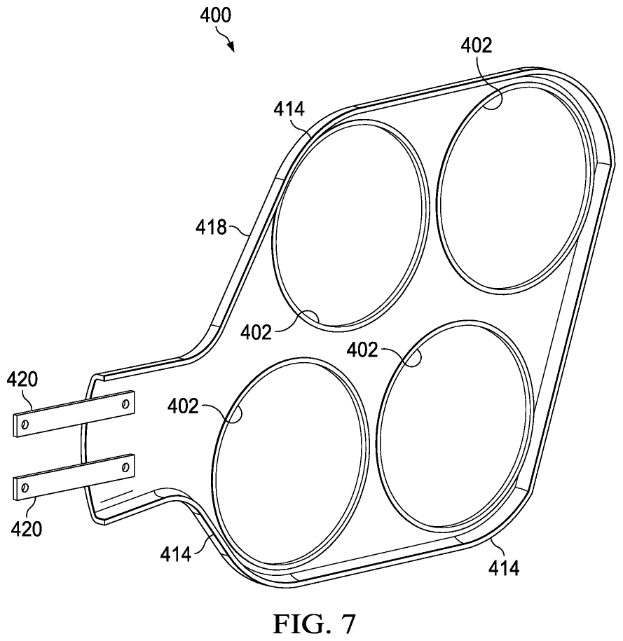

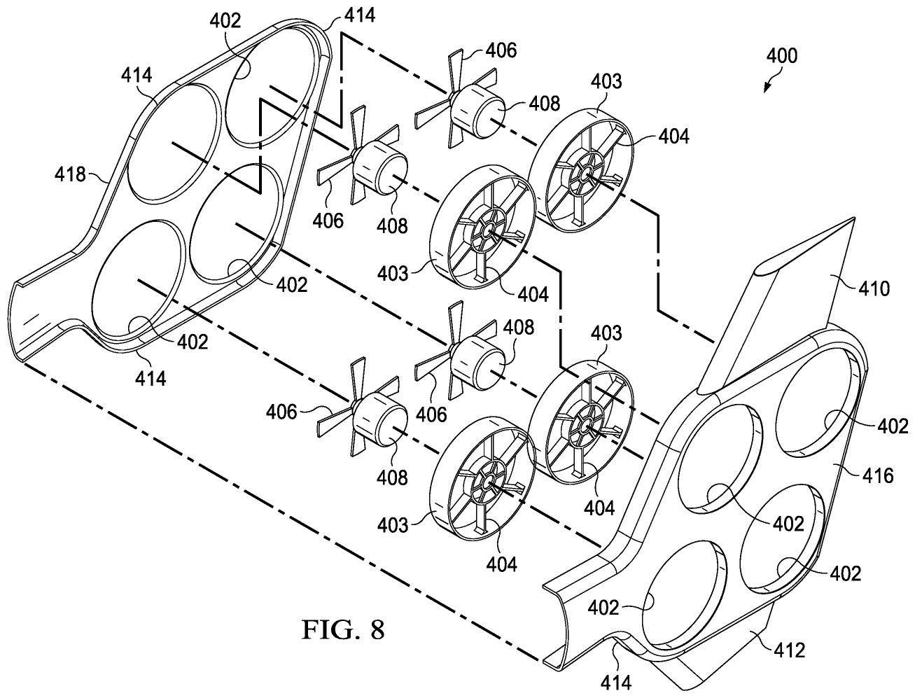

Referring now to FIGS. 5-8, an alternative embodiment of a DPSS 400 is shown. FIG. 5 is an end view of a multi-portion monocoque configuration of DPSS 400. This embodiment can comprise a first portion 416 and a second portion 418. First portion 416 and second portion 418 can be constructed of metal, metal alloys, carbon fiber, and/or any other suitable material or composite construction. In some cases, first portion 416 and second portion 418 can be constructed using machining and/or casting processes. DPSS 400 comprises an assembly joint 414 where first portion 416 and second portion 418 can be joined together. In this embodiment, when first portion 416 and second portion 418 are joined along assembly joint 414, the resultant combination is substantially similar in shape and function to structural body 201. Assembly joint 414 can comprise a variety of joint geometries and the first portion 416 and second portion 418 can be joined using one or more of a variety of joining techniques, such as bonding, fasteners, clamping, etc. In this embodiment, four fan apertures 402 extend fully through the first portion 416 and the second portion 418. In each fan aperture 402, a duct 403, a fan motor mount 404, a fan motor 408, and a fan blade assembly 406 are disposed in fan aperture 402 so that during operation of the EDAT 112, air can be selectively passed through the fan apertures 402. While the ducts 403 and fan motor mounts 404 are provided as separate components, in alternative embodiments, the ducts 403 and/or the motor mounts 404 can be integrally formed with one of the first portion 416 and second portion 418. In this embodiment, each fan motor mount 404 is supported by first portion 416 so that forces generated by the EDAT 112 are transferred from the fan motor mounts 404 to the first portion 416, to the adjoined second portion 418, and ultimately to the tail boom 106 via tail boom adapter 420. In alternative embodiments, fan motor mounts can be connected to and supported by second portion 418, or can be connected to and supported by both the first portion 416 and the second portion 418. In this embodiment, an upper vertical stabilizer 410 and a lower vertical stabilizer 412 are mounted to first portion 416. In other possible embodiments, upper vertical stabilizer 410 and lower vertical stabilizer 412 can be mounted to second portion 418, or can be connected to and supported by both of the first portion 416 the second portion 418. Still further, in some embodiments, one or both of the upper vertical stabilizer 410 and the lower vertical stabilizer 412 can be integrally formed with one of the first portion and the second portion. Tail boom adapter 420 structurally couples DPSS 400 to tail boom 106 of rotorcraft 100, and an electrical power source 114, such as a battery or a generator, is connected to electrical wiring 422 to power fan motors 408.

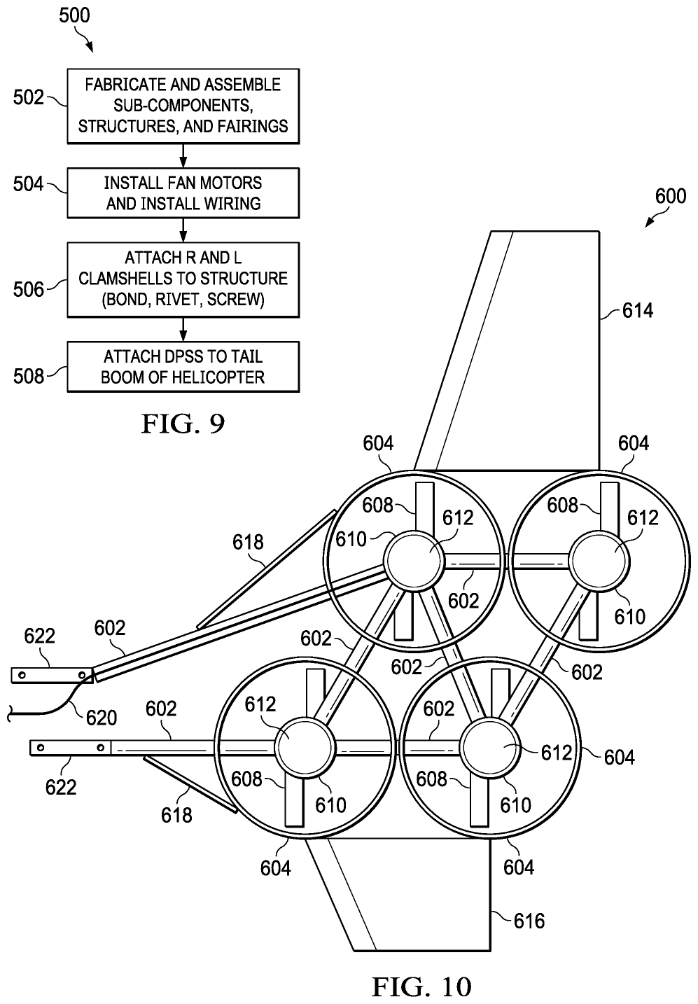

Referring to FIG. 9, a flowchart of a method 500 of constructing a DPSS 400 is shown. At block 502, method 500 can begin by fabricating a first portion such as first portion 416, a second portion such as second portion 418, an upper vertical stabilizer such as upper vertical stabilizer 410, and lower vertical stabilizer such as lower vertical stabilizer 412. Method 500 can continue at block 504 by installing fan motor mounts, fan motors, fan blades assemblies, and electrical wiring 422 to an interior space of one of the first portion and the second portion and the related fan apertures. Method 500 can continue at block 506 by joining the first portion to the second portion, and connecting the upper vertical stabilizer and lower vertical stabilizer to at least one of the first portion and the second portion. At block 508 method 500 can progress by structurally joining DPSS 400 to tail boom 106 via a tail boom adapter, thereby fully structurally supporting EDAT 112 by the tail boom 106 via DPSS 400, and connecting the electrical power source of the rotorcraft to the electrical wiring such as electrical wiring 422 to selectively power the fan motors.

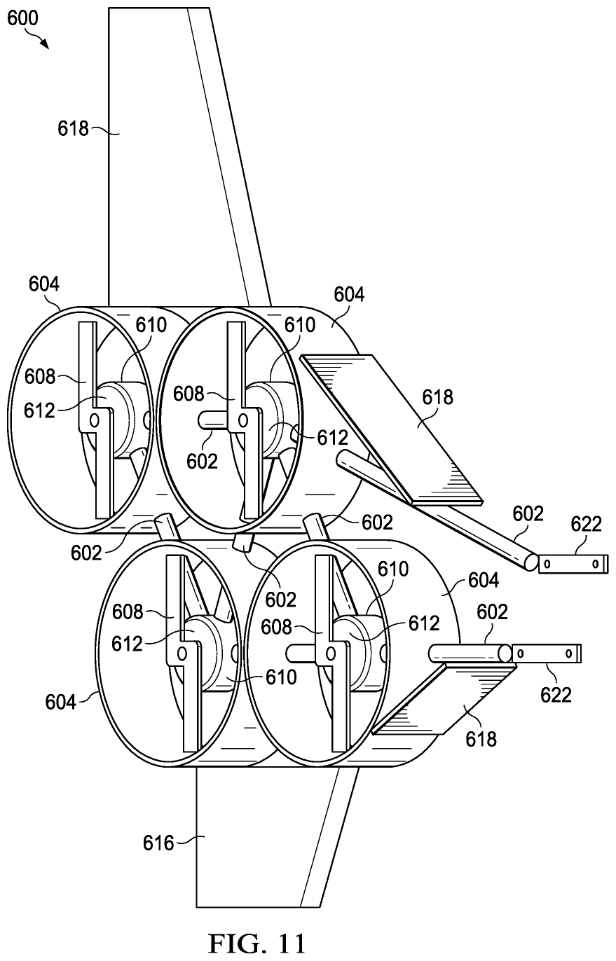

Referring now to FIGS. 10 and 11, another alternative embodiment of a DPSS 600 is shown that can carry an EDAT 112. In this embodiment, DPSS 600 comprises structural members 602, fan motor mounts 610, fan motors 612, fan blade assemblies 608, and fan ducts 604. In this embodiment, four fan ducts 604 are provided, although in other embodiments, two, three, or more than four fan ducts 604 can be provided. Still further, in alternative embodiments, DPSS 600 may comprise a greater number of fan ducts 604 than fan motors 612, fewer fan ducts 604 than fan motors 612, or even no fan ducts 604. Fan motor mounts 610, fan motors 612 and fan blade assemblies 608 are generally coaxially disposed in associated fan ducts 604. As compared to DPSS 200 and DPSS 400, DPSS 600 is different at least because the structural loads acting on DPSS 600 are distributed through the fan motor mounts 610 and the structural members 602 that join the fan motor mounts 610 into a static array. Fan motor mounts 610 and structural members 602 can comprise alloys, composites, carbon fiber, or any other suitable combination of materials. In this embodiment fan ducts 604 can be utilized as additional structural elements that distribute and carry loads imparted on upper vertical stabilizer 614 and lower vertical stabilizer 616 to the fan motor mounts 610 and structural members 602. In alternative embodiments, the fan ducts 604 can be lightweight nonstructural components. In yet other alternative embodiments, structural members 602 can comprise hollow tubes that can serve a secondary function of being a conduit for receiving electrical wiring 620 for connecting fan motors 612 to the electrical power source 114. In this embodiment, nonstructural fairings 618 are provided to reduce aerodynamic drag on the DPSS 600 in forward flight. The tail boom adapter 622 structurally couples DPSS 600 to tail boom 106 of rotorcraft 100. In an alternative embodiment of a DPSS substantially similar to DPSS 600, a DPSS can comprise fewer structural members 602 and can rely on a joinder of adjacent structural fan ducts to transfer loads within the DPSS.

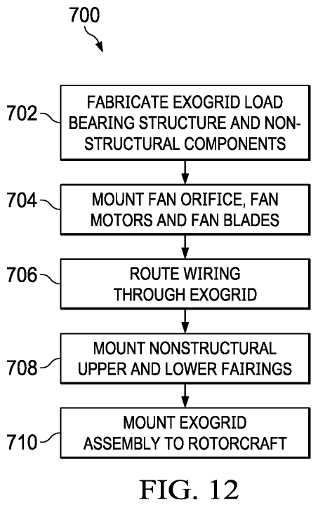

Referring to FIG. 12, a flowchart of a method 700 of producing a DPSS 600 is shown. Method 700 can begin at block 702 by fabricating and providing fan motor mounts such as fan motor mounts 610, structural members such as structural members 602, fan ducts such as fan ducts 604, an upper vertical stabilizer such as upper vertical stabilizer 614, lower vertical stabilizer such as lower vertical stabilizer 616, and nonstructural fairings such as nonstructural fairings 618. Method 700 can continue at block 704 by assembling the fan motor mounts, the structural members, the fan ducts, the fan motors, and the fan blade assemblies. Next at block 706 the method 700 can continue by routing electrical wiring to fan motors, optionally through an interior of the structural members. At block 708 the method 700 can continue by mounting the upper vertical stabilizer, the lower vertical stabilizer, and the nonstructural fairings. And lastly, in block 710, DPSS 600 is mounted to tail boom 106 of rotorcraft 100 using a tail boom adapter such as tail boom adapter 622, and the electrical power source 114 of rotorcraft 100 is connected to electrical wiring 620 to power the fan motors 612 carried by DPSS 600.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A rotorcraft, comprising:
a substantially rigid structural body, comprising:
an internal cavity; and
an aperture extending entirely through the structural body;
at least one of a tail boom and a fuselage; and
a propulsion device disposed at least partially within the internal cavity and at least partially within the aperture;
wherein the propulsion device is carried by the structural body so that forces are transferred from the propulsion device to at least one of the tail boom and the fuselage via the structural body.

2. The rotorcraft of claim 1, wherein the structural body comprises at least one of (1) a composite structural material comprising carbon fiber and epoxy and (2) metal.

3. The rotorcraft of claim 1, wherein the propulsion device comprises an electrically powered fan motor.

4. The rotorcraft of claim 1, wherein the structural body additionally carries a stabilizer.

5. The rotorcraft of claim 4, wherein the stabilizer is integrally formed with the structural body.

6. The rotorcraft of claim 1, further comprising:
a stiffening material disposed within the internal cavity.

7. The rotorcraft of claim 6, wherein the stiffening material is formed to comprise tubular cavities configured to provide a route between the propulsion device and a power source for powering the propulsion device.

8. The rotorcraft of claim 1, wherein at least one of (1) a tail boom adapter is connected between the structural body and the tail boom, (2) the structural body is integrally formed with a portion of the tail boom, and (3) the structural body is integrally formed with a portion of the fuselage.

9. The rotorcraft of claim 1, the structural body further comprising:
a first portion;
a second portion; and
an assembly joint comprising a portion of the first portion and a portion of the second portion.

10. The rotorcraft of claim 9, wherein the first portion is joined to the second portion so that the structural body transmits load substantially as a unitary rigid structure.

11. A rotorcraft, comprising:
at least one of a tail boom and a fuselage;
a first propulsion device;
a second propulsion device;
a first structural member providing a load path between the first propulsion device and at least one of the tail boom and the fuselage; and
a second structural member providing a load path between the first propulsion device and the second propulsion device.

12. The rotorcraft of claim 11, wherein at least one of the first propulsion device and the second propulsion device comprises an electrically powered fan motor.

13. The rotorcraft of claim 12, further comprising:
a motor mount connected between the first propulsion device and the first structural member.

14. The rotorcraft of claim 12, further comprising:
a motor mount connected between the first propulsion device and the second propulsion device.

15. The rotorcraft of claim 11, further comprising:
a first duct associated with the first propulsion device.

16. The rotorcraft of claim 15, wherein the first duct is connected to the first structural member to provide a load path between the first propulsion device and at least one of the tail boom and the fuselage.

17. The rotorcraft of claim 16, further comprising:
a second duct associated with the second propulsion device.

18. The rotorcraft of claim 17, wherein the second duct is connected to the second structural member to provide a load path between the second propulsion device and at least one of the tail boom and the fuselage.

19. The rotorcraft of claim 17, wherein the second duct is connected to the first duct to provide a load path between the second propulsion device and the first structural member.

20. The rotorcraft of claim 17, wherein at least one of a stabilizer and a nonstructural fairing are connected to at least one of the tail boom and the fuselage via at least one of the first duct and the second duct.
